(19) United States
(12) Patent Application Publication
(10) Pub. No.: US 2010/0054887 A1
(43) Pub. Date: Mar. 4, 2010

(54) MACHINE TOOL WITH A PLURALITY OF WORKTABLES

(76) Inventor: Feng-Tien Chen, Taichung Hsien (TW)

Correspondence Address: SHEPPARD, MULLIN, RICHTER & HAMPTON LLP, 990 Marsh Road, Menlo Park, CA, 94025, US

(21) Appl. No.: 12/200,632

(22) Filed: Aug. 28, 2008

(51) Int. Cl. B23C 9/00

(52) U.S. Cl. 409/163

(57) ABSTRACT

A machine tool includes a support unit and a pair of spaced-apart worktable units. The support unit includes a base seat, a support seat mounted fixedly on one end of the base seat, a carriage disposed movably on the support seat and movable in a first direction, and a spindle stock, movable on the carriage in a second direction transverse to the first direction, and provided with a spindle that extends in a third direction transverse to the first and second directions. Each of the worktable units includes a pair of slide rails, each of which is mounted fixedly on the base seat and extends in the third direction, a worktable that is movable along the slide rails, and a motor that is disposed for driving the worktable to move along the slide rails.

### BACKGROUND OF THE INVENTION

1. Field of the Invention

The invention relates to a machine tool, more particularly to a machine tool with a plurality of worktables.

2. Description of the Related Art

As shown in FIG. 1, a conventional machine tool 10 includes a base seat 11, a carriage 13 mounted on one end of the base seat 11 and movable in a left-right direction, a spindle stock 14 disposed on the carriage 13 and movable in a vertical direction, and a worktable unit 15 disposed on the base seat 11 and movable in a front-rear direction. The base seat 11 is provided with a pair of slide rails 111 that extend in the front-rear direction, a pair of driving screws 112, and a pair of servo motors 113, each of which is disposed at one end of a respective one of the driving screws 112, such that the driving screws 112 can be driven to rotate by the servo motors 113, respectively, thereby driving the worktable unit 15 to move along the slide rails 111. The spindle stock 14 is provided with a spindle 141 that extends in the front-rear direction that permits a cutter (not shown) to be mounted thereon. The worktable unit 15 includes a rotatable seat 151, and a pair of worktables 152 disposed respectively at two ends of the rotatable seat 151. When the conventional machine tool 10 is in use, each of the worktables 152 holds a workpiece (not shown), and the worktable unit 15 is driven to move along the slide rails 111 of the base seat 11 toward the spindle stock 14, such that one of the worktables 152 is at a position adjacent to the spindle stock 14, and that the workpiece held thereon is cut by the cutter. Afterward, the worktable unit 15 is moved away from the spindle stock 14, and the rotatable seat 151 is rotated until the positions of the worktables 152 are interchanged with each other, such that the processed workpiece can be conveniently removed from the one of the worktables 152 and that a new workpiece is held on the one of the worktables 152, while the workpiece held on the other one of the worktables 152 can be cut by the cutter when the worktable unit 15 is moved again to the position adjacent to the spindle stock 14. Therefore, the conventional machine tool 10 is capable of cutting workpieces continuously.

However, since each of the worktables 152 is relatively small, the size of the workpiece disposed thereon is limited. If the worktables 152 support oversized workpieces, the speed of the rotatable seat 151 will become slow, thereby resulting in a relatively low operating efficiency.

### SUMMARY OF THE INVENTION

Therefore, the object of the present invention is to provide a machine tool with a greater flexibility in processing different sizes of workpieces.

Accordingly, a machine tool of the present invention comprises a support unit and a pair of spaced-apart worktable units. The support unit includes a base seat, a support seat that is mounted fixedly on one end of the base seat, a carriage that is disposed movably on the support seat and that is movable in a first direction, and a spindle stock that is disposed movably on the carriage, that is movable on the carriage in a second direction transverse to the first direction, and that is provided with a spindle extending in a third direction transverse to the first and second directions. The worktable units are disposed on the base seat of the support unit. Each of the worktable units includes a pair of slide rails, each of which is mounted fixedly on the base seat of the support unit and extends in the third direction, a worktable that is movable along the slide rails, and a motor that is disposed for driving the worktable to move along the slide rails.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional machine tool;

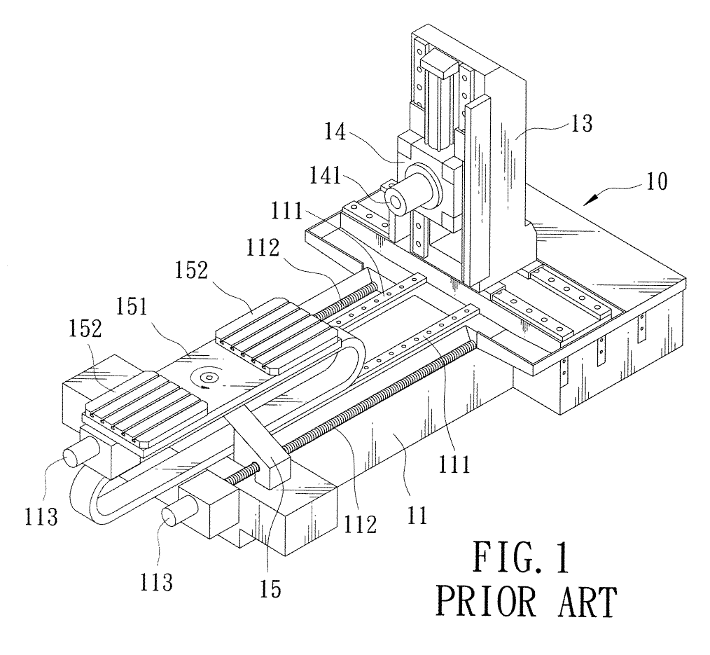

FIG. 2 is a perspective view of a first preferred embodiment of a machine tool according to the invention;

FIG. 3 is a fragmentary front view of the first preferred embodiment;

FIG. 4 is a top view of the first preferred embodiment;

FIG. 5 is a side view of the first preferred embodiment;

FIG. 6 is another top view of the first preferred embodiment, illustrating operation of a pair of worktable units;

FIG. 7 is another perspective view of the first preferred embodiment, illustrating the worktable units interconnected by a connecting plate;

FIG. 8 is a fragmentary front view of the first preferred embodiment, illustrating the worktable units interconnected by the connecting plate;

FIG. 9 is still another top view of the first preferred embodiment, illustrating the worktable units interconnected by the connecting plate; and

FIG. 10 is a fragmentary front view of a second preferred embodiment of the machine tool according to the invention.

### DETAILED DESCRIPTION OF THE PREFERRED EMBODIMENTS

Before the present invention is described in greater detail, it should be noted that like elements are denoted by the same reference numerals throughout the disclosure.

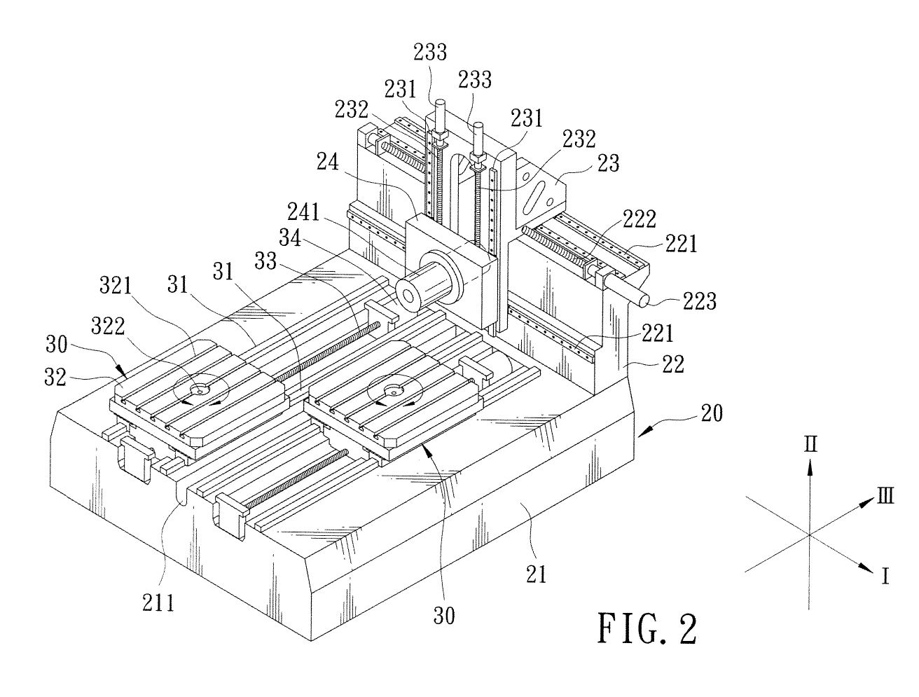

As shown in FIG. 2, the first preferred embodiment of a CNC (Computer-Numerical-Controlled) machine tool according to the present invention comprises a support unit 20, and a pair of worktable units 30.

The support unit 20 includes a base seat 21, a support seat 22 that is mounted fixedly on one end of the base seat 21, a carriage 23 that is disposed movably on the support seat 22, and a spindle stock 24 that is disposed movably on the carriage 23. The support seat 22 has a plurality of spaced-apart first slide rails 221 that are mounted thereon, that extend in a first direction (I), and that permit the carriage 23 to be movably disposed thereon, a first driving screw 222 that is disposed at a top end thereof and that extends drivingly through the carriage 23, and a first motor 223 that is connected to the first driving screw 222 so as to drive the carriage 23 to move in the first direction (I) relative to the base seat 21. The carriage 23 has a pair of spaced-apart second slide rails 231 that are disposed respectively at two lateral sides thereof, that extend in a second direction (II) transverse to the first direction (I), and that permit the spindle stock 24 to be disposed movably thereon, a pair of second driving screws 232 that are disposed respectively adjacent to the second slide rails 231 and that extend drivingly through the spindle stock 24, and a pair of second motors 233 that are connected respectively to the second driving screws 232 so as to drive the spindle stock 24 to move in the second direction (II) relative to the carriage 23. The spindle stock 24 is provided with a spindle 241 that extends in a third direction (III) transverse to the first and second directions (I, II) and that is mounted with a cutter (not shown).

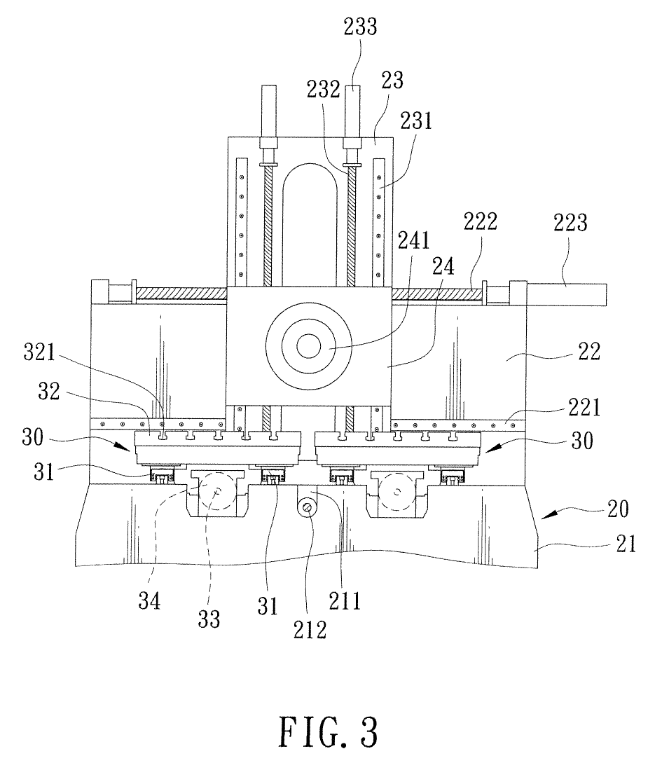

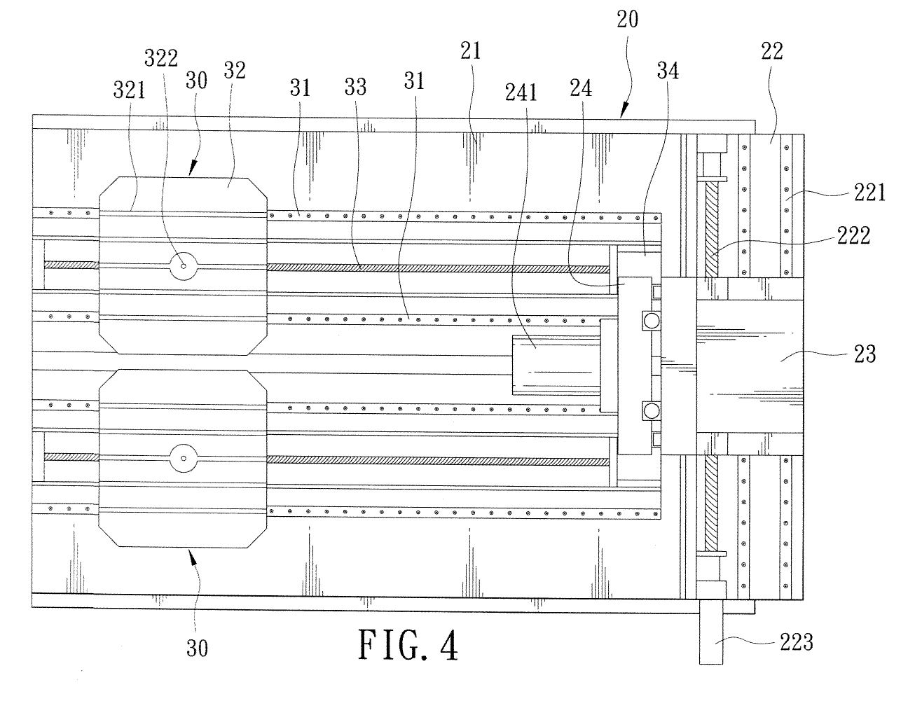

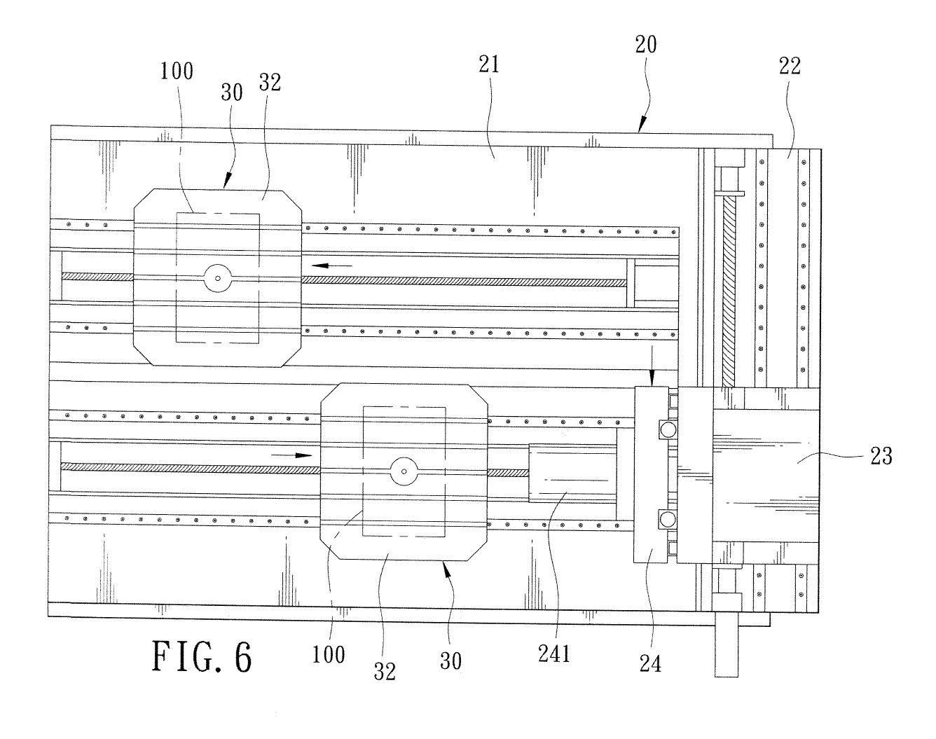

As shown in FIGS. 2 to 4, the worktable units 30 are disposed on the base seat 21 of the support unit 20 and are spaced apart from each other in the first direction (I). Each of the worktable units 30 includes a pair of third slide rails 31, each of which is mounted fixedly on the base seat 21 of the support unit 20 and extends in the third direction (II), a worktable 32 that is movable along the third slide rails 31, a third driving screw 33 that extends in the third direction (III) and that extends drivingly through the worktable 32, and a motor 34 that is disposed at one end of the third driving screw 33 for driving the worktable 32 to move along the third slide rails 31. The worktable 32 of each of the worktable units 30 has a top surface formed with a plurality of T-slots 321, such that fasteners (not shown) can be provided to engage the T-slots 321 and secure a workpiece 100 (see FIG. 6) on the worktable 32. In this embodiment, the worktable 32 further has a rotating shaft 322 connected fixedly to and extending perpendicularly from the center thereof, such that the worktable 32 can be rotated about the rotating shaft 322, i.e., the worktable 32 is rotatable and slidable on the third slide rails 31. The motor 34 of each of the worktable units 30 may be one of an alternating current motor, a servo motor, and a linear motor. In this embodiment, the motor 34 of each of the worktable units 30 is a servo motor. The base seat 21 of the support unit 20 has a top surface formed with a chip collecting slot 211 disposed between the worktable units 30 and extending in the third direction (III), and a chip removing screw 212 threaded in the chip collecting slot 211 for removing chips in the chip collecting slot 211 during operation of the machine tool and maintaining the precision of the machine tool.

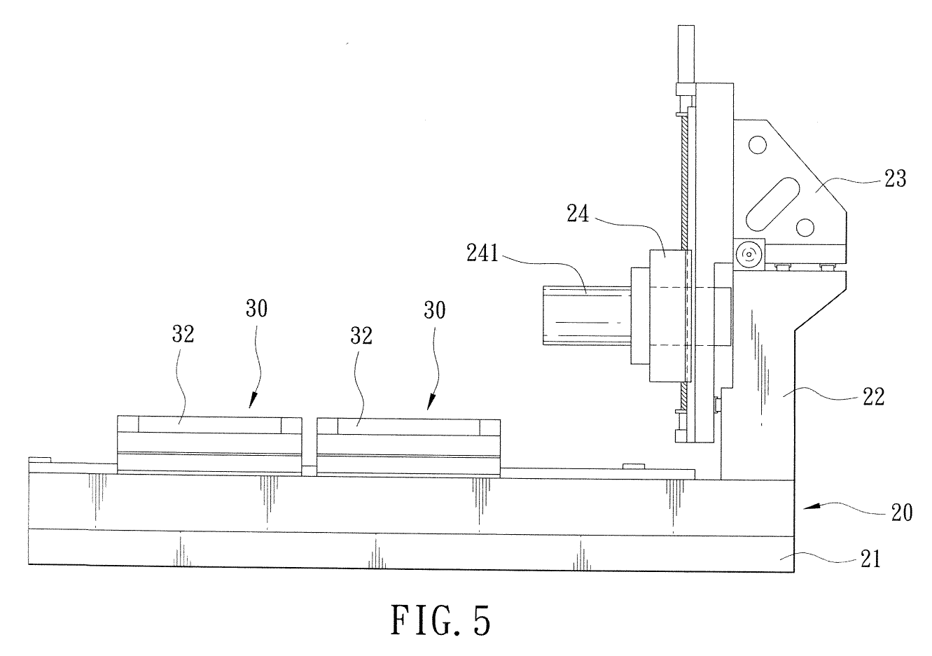

Referring to FIGS. 5 and 6, the worktable 32 of each of the worktable units 30 holds a workpiece 100 before the machine tool of the first preferred embodiment is in use. During operation of the machine tool of the first preferred embodiment, the worktable 32 of one of the worktable units 30 is moved to a position adjacent to the spindle stock 24 of the support unit 20 so that the workpiece 100 held thereon can be cut by the cutter that is mounted on the spindle 241. Afterward, the worktable 32 of the one of the worktable units 30 is moved away from the spindle stock 24 such that the processed workpiece 100 held thereon can be removed from the worktable 32 and that a new workpiece 100 can be placed thereon, while the worktable 32 of the other one of the worktable units 30 is moved toward the spindle stock 24 so that the workpiece 100 held thereon can be cut by the cutter. By virtue of the alternate movement of the worktables 32, the machine tool of the first preferred embodiment is capable of cutting workpieces 10 continuously.

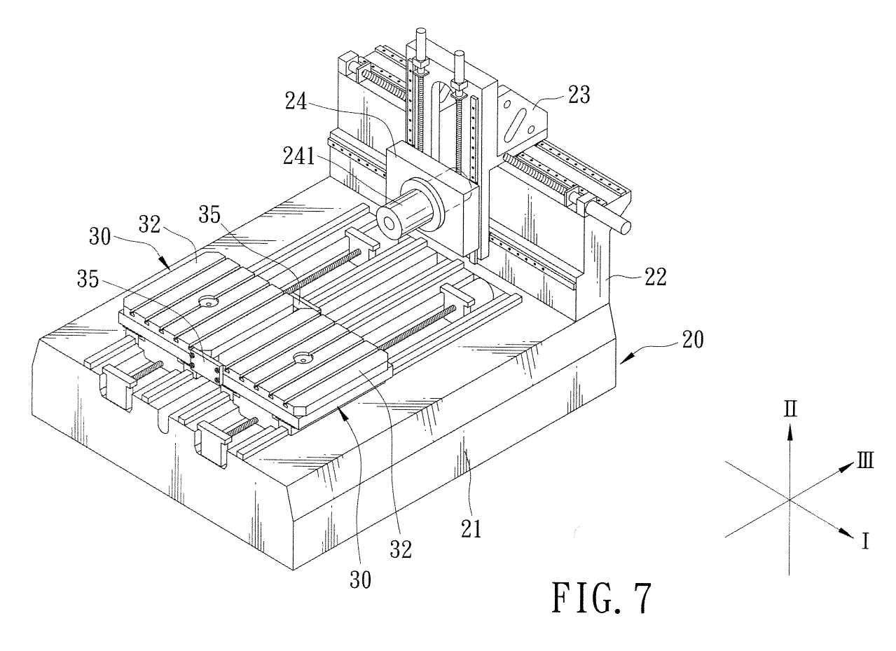

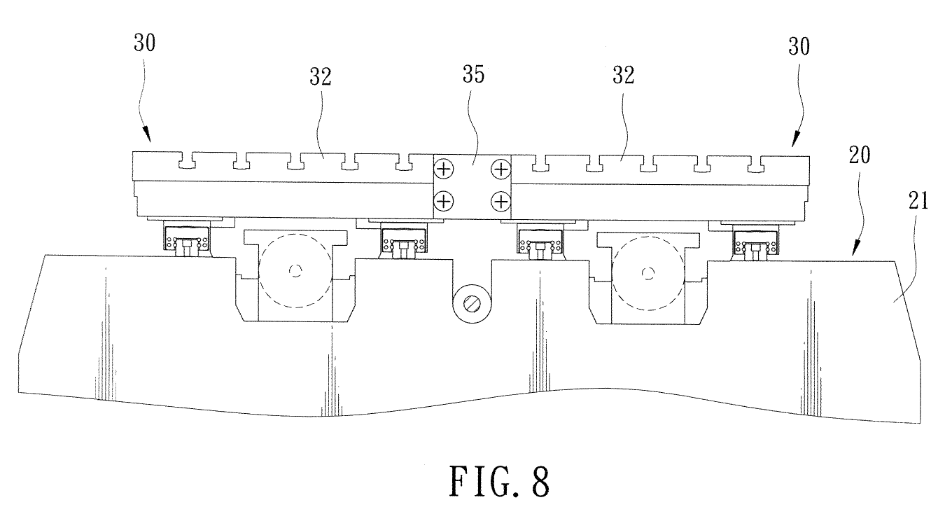

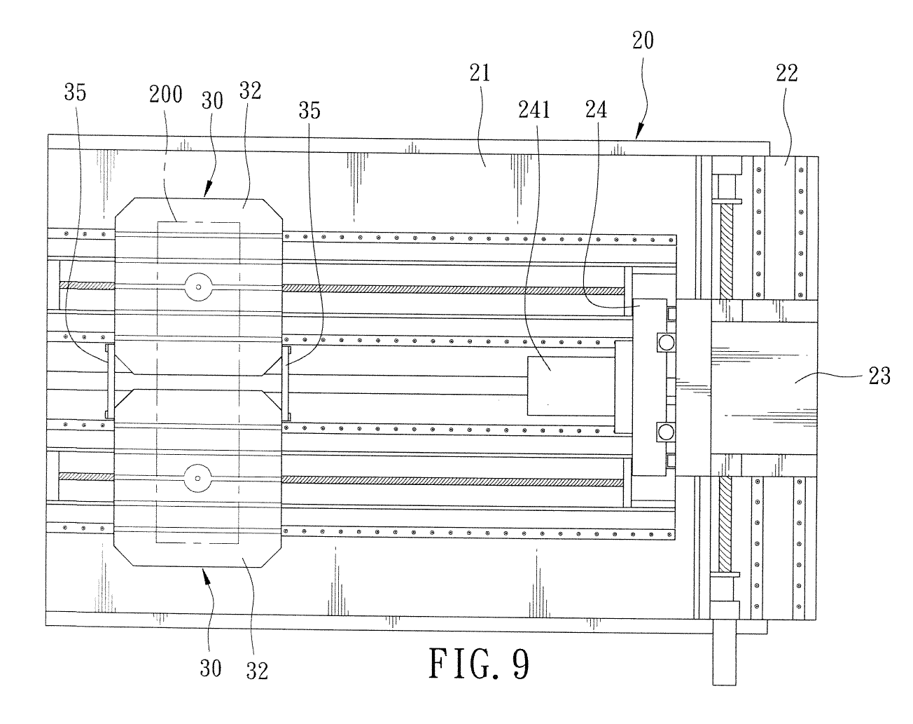

As shown in FIGS. 7 to 9, the machine tool of the first preferred embodiment further comprises a pair of connecting plates 35 for interconnecting detachably the worktables 32 of the worktable units 30. Under the application of the connecting plates 35, the worktables 32 are united to move simultaneously relative to the spindle stock 24, such that a workpiece 200 of a larger size can be held on the worktables 32. Therefore, as compared to the above-mentioned prior art, the machine tool of the first preferred embodiment has a greater flexibility in processing workpieces of different sizes.

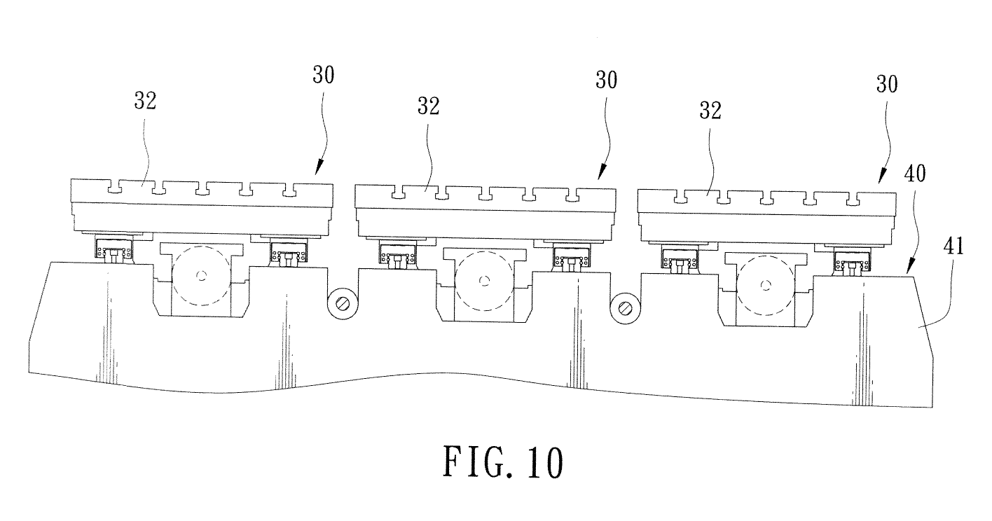

As shown in FIG. 10, the second preferred embodiment of the machine tool according to the present invention has a structure similar to that of the first preferred embodiment. The main difference between this embodiment and the previous embodiment resides in the following. The machine tool includes a support unit 40 that has a base seat 41, and three spaced-apart worktable units 30 that are mounted on the base seat 41, each of the worktable units 30 including a movable worktable 32. Therefore, the second preferred embodiment further enhances the flexibility in processing workpieces of different sizes.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A machine tool comprising:
a support unit including
a base seat,
a support seat that is mounted fixedly on one end of said base seat,
a carriage that is disposed movably on said support seat and that is movable in a first direction, and
a spindle stock that is disposed movably on said carriage, that is movable on said carriage in a second direction transverse to the first direction, and that is provided with a spindle extending in a third direction transverse to the first and second directions; and
a pair of spaced-apart worktable units disposed on said base seat of said support unit, each of said worktable units including
a pair of slide rails, each of which is mounted fixedly on said base seat of said support unit and extends in the third direction,
a worktable that is movable along said slide rails, and
a motor that is disposed for driving said worktable to move along said slide rails.

2. The machine tool as claimed in claim 1, further comprising a connecting plate interconnecting detachably said worktables of said worktable units.

3. The machine tool as claimed in claim 1, wherein said base seat of said support unit has a top surface formed with a chip collecting slot disposed between said worktable units and extending in the third direction, and a chip removing screw threaded in said chip collecting slot.

4. The machine tool as claimed in claim 1, wherein said motor of each of said worktable units is one of an alternating current motor, a servo motor, and a linear motor.

5. The machine tool as claimed in claim 1, wherein said worktable of each of said worktable units is rotatable and slidable on said slide rails.
